(19) United States
(12) Patent Application Publication
(10) Pub. No.: US 2013/0108269 A1
(43) Pub. Date: May 2, 2013

(54) APPARATUS AND METHOD FOR CONTROLLING VPN SERVICE

(71) Applicants: Byeong-Sik KIM, Daejeon-si (KR); Seung-Hyun YOON, Daejeon-si (KR); You-Hyeon JEONG, Daejeon-si (KR); Ho-Young SONG, Daejeon-si (KR)

(72) Inventors: Byeong-Sik KIM, Daejeon-si (KR); Seung-Hyun YOON, Daejeon-si (KR); You-Hyeon JEONG, Daejeon-si (KR); Ho-Young SONG, Daejeon-si (KR)

(73) Assignee: Electronics and Telecommunications Research Institute, Daejeon-si (KR)

(21) Appl. No.: 13/584,160

(22) Filed: Aug. 13, 2012

(30) Foreign Application Priority Data
Nov. 1, 2011 (KR) 10-2011-0113034

(51) Int. Cl. G06F 21/20; G06F 15/173; H04B 10/20

(52) U.S. Cl. 398/58; 726/15

(57) ABSTRACT

An apparatus and method of controlling virtual private network (VPN) services are provided. The apparatus according to an embodiment of the present invention includes a profile definition unit that defines a service profile required for VPN setting between edge devices connected to a carrier ethernet backbone network via an access network, and a VPN setting and management unit that sets a VPN connecting the carrier ethernet backbone network and the access network based on the service profile defined by the profile definition unit, and centrally manages the carrier ethernet backbone network and the access network to provide the VPN services.

### CROSS-REFERENCE TO RELATED APPLICATION

This application claims the benefit under 35 U.S.C. §119(a) of Korean Patent Application No. 10-2011-0113034, filed on Nov. 1, 2011, the entire disclosure of which is incorporated herein by reference for all purposes.

### BACKGROUND

1. Field

The following description relates to network management and service technology, and more particularly, to service control technology in a virtual private network.

2. Description of the Related Art

A method in which a public network such as the Internet is used as if a private network is constructed through a dedicated line is referred to as a virtual private network (hereinafter, referred to as “VPN”). In VPN, an internal private communication network of a corporation is only connected with the public Internet, so that it is unnecessary to purchase and manage separate expensive equipment or software, thereby significantly reducing costs compared to an existing private network connection method.

In addition, telecommuters, workers who frequently travel, and current workers are connected to a corporate private network through Internet service providers and the Internet, whereby data sharing between a head office and branches, between branches, and between internal and external staff is readily performed in a flexible and inexpensive manner.

As related art associated with a service control technique in the VPN, Korean Patent No. 10-2005-0050787 discloses technology in which a bandwidth is changed at a scheduled time and Metro Ethernet service subscribers are notified. In addition, Korean Patent No. 10-2011-0040652 discloses technology in which a VPN gateway converts an address of a mobile terminal into a VPN internal address available in the VPN so that VPN services are provided to the mobile terminal even while the mobile terminal is moving.

However, the above-described related art is concerned only with technology providing the VPN services in a carrier ethernet zone. In practice, service subscribers are connected to the carrier ethernet network via an access network.

Accordingly, to smoothly provide the VPN services to the service subscribers, it is required to control connection between edges by controlling devices of an access zone in addition to the carrier ethernet zone.

### SUMMARY

The following description relates to a virtual private network (hereinafter, referred to as “VPN”) service control apparatus and method that control devices constituting a carrier ethernet backbone network configured by a carrier ethernet technique and an FTTH-based access network to thereby provide reliable VPN services between edges.

In one general aspect, there is provided an apparatus for controlling VPN services between edge devices in an integrated network environment including a carrier ethernet backbone network and an access network, the apparatus including: a profile definition unit that defines a service profile required for VPN setting between the edge devices connected to the carrier ethernet backbone network via the access network; and a VPN setting and management unit that sets a VPN connecting the carrier ethernet backbone network and the access network based on the service profile defined by the profile definition unit, and centrally manages the carrier ethernet backbone network and the access network to provide the VPN services.

In another general aspect, there is provided a method of controlling VPN services by an apparatus for controlling the VPN services in an integrated network environment including a carrier ethernet backbone network and an access network, the method including: defining a service profile required for VPN setting between edge devices connected to the carrier ethernet backbone network via the access network; setting a VPN connecting the carrier ethernet backbone network and the access network based on the defined service profile; and centrally managing the carrier ethernet backbone network and the access network to provide the VPN services.

Other features and aspects will be apparent from the following detailed description, the drawings, and the claims.

### BRIEF DESCRIPTION OF THE DRAWINGS

FIG. 1 is a network structure diagram illustrating an integrated network environment including a carrier ethernet backbone network and an access network according to an embodiment of the present invention;

FIG. 2 is a configuration diagram illustrating an apparatus for providing virtual private network (hereinafter, referred to as VPN) services according to an embodiment of the present invention;

FIG. 3 is a detailed configuration diagram illustrating a profile definition unit according to an embodiment of the present invention;

FIG. 4 is a detailed configuration diagram illustrating a VPN setting and management unit according to an embodiment of the present invention;

FIGS. 5 to 7 are example diagrams illustrating a selection example of a service type to be used in a carrier ethernet backbone network for providing VPN services according to a variety of embodiments of the present invention;

FIG. 8 is a flowchart illustrating a method of providing VPN services between edge devices of an apparatus for controlling the VPN services in an integrated network environment including a carrier ethernet backbone network and an access network according to an embodiment of the present invention;

FIG. 9 is a flowchart illustrating in detail a VPN setting process of an access network in a VPN setting process of FIG. 8; and

FIG. 10 is a flowchart illustrating in detail a VPN setting process of a carrier ethernet backbone network in a VPN setting process of FIG. 8.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

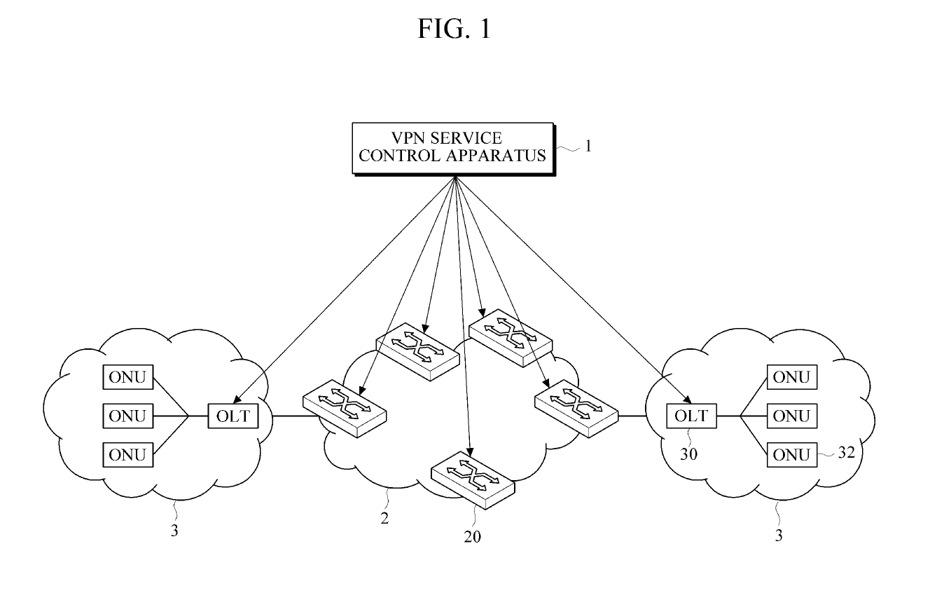

FIG. 1 is a network structure diagram illustrating an integrated network environment including a carrier ethernet backbone network and an access network according to an embodiment of the present invention.

Referring to FIG. 1, an integrated network for providing virtual private network (hereinafter, referred to as “VPN”) services includes a carrier ethernet backbone network 2 and an access network 3.

The carrier ethernet backbone network 2 includes a provider edge 20 (hereinafter, referred to as “PE”). The PE 20 is equipment positioned at an edge of the carrier ethernet backbone network 2 for providing the VPN services.

Service subscribers are connected to the carrier ethernet backbone network 2 via the access network 3. The access network 3 may be provided in plural. As types of the access network 3, FTTO, FTTH, FTTC, HFC, HFR, PON, WLL, and the like may be given. In the present invention, an FTTH-based access network will be described, but the access network of the present invention is not limited thereto.

The FTTH-based access network includes an optical line terminal 30 (hereinafter, referred to as “OLT”) and a plurality of subscriber optical network units 32 (hereinafter, referred to as “ONU”) as shown in FIG. 1.

The VPN services including the carrier ethernet backbone network 2 and the access network 3 are to provide a dedicated private line between the ONUs positioned at the edges. The VPN is a network concept when data forwarding is performed from one of two devices to the other via a public network as if the two devices are directly connected.

Accordingly, subscribers connected to each of the ONUs positioned at the edges may be provided with services such as in a dedicated line through which the subscribers are mutually directly connected.

To provide the VPN services between the edges, it is required to control connection between edges by controlling devices of an access zone in addition to a carrier ethernet zone. However, the Metro Ethernet Forum mentions only about a technique of providing services through setting of ethernet virtual connection (hereinafter, referred to as “EVC”) in the carrier ethernet zone. Accordingly, the present invention proposes an apparatus 1 for controlling VPN services to provide the VPN services through which transmission quality between edges is ensured by controlling edge devices which constitute the carrier ethernet backbone network 2 configured by a carrier ethernet technique and the FTTH-based access network 3.

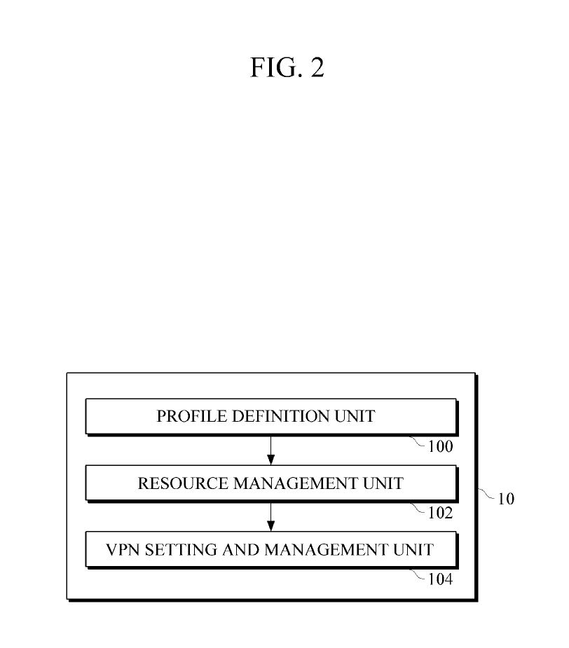

FIG. 2 is a configuration diagram illustrating an apparatus 1 for providing VPN services according to an embodiment of the present invention.

Referring to FIGS. 1 and 2, the apparatus 1 includes a profile definition unit 100 and a VPN setting and management unit 104, and further includes a resource management unit 102.

The profile definition unit 100 defines a service profile required for VPN setting between edge devices which are connected to the carrier ethernet backbone network 2 via the access network 3.

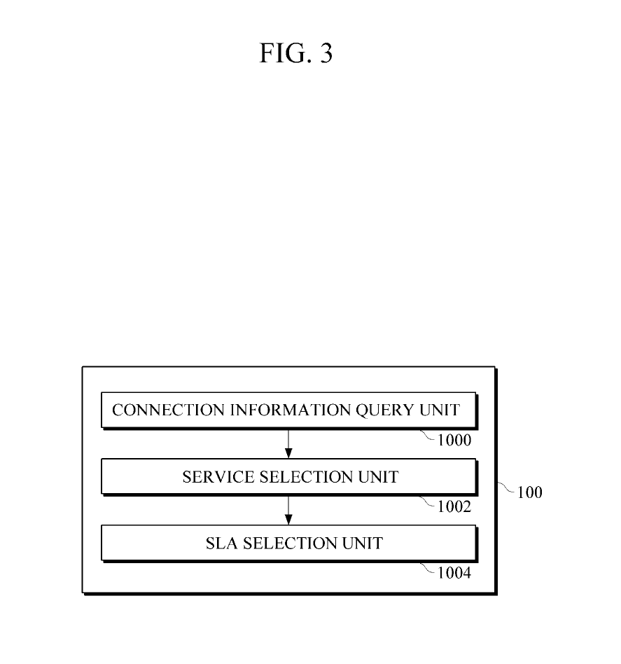

The service profile includes subscriber information, subscriber connection information, service type information, and service quality information. A detailed configuration of the profile definition unit 100 will be described below with reference to FIG. 3.

The VPN setting and management unit 104 sets a VPN connecting the carrier ethernet backbone network 2 and the access network 3 using the service profile defined by the profile definition unit 100, and integrally manages the set VPN. In this instance, the VPN setting and management unit 104 performs network management for providing the VPN services in a centralized manner. That is, the VPN setting and management unit 104 not only manages the carrier ethernet backbone network 2 but also centrally manages the carrier ethernet backbone network 2, the access network 2, and the linked carrier ethernet backbone network 2 and access network 3 at a center.

As an example of the VPN setting, the VPN setting and management unit 104 receives a setting request message for the VPN services from each of the edge devices of the carrier ethernet backbone network 2 and the access network 3 and determines service information required for the VPN setting.

As an example, when receiving a setting/canceling message of the VPN services from each of the edge devices of the carrier ethernet backbone network 2 and the access network 3, the VPN setting and management unit 104 sets an interface required to be set/canceled in a case of setting or canceling VPN service connection based on the received message and sets a tunnel for the VPN.

As an example of VPN integrated management, the VPN setting and management unit 104 manages service information about a service use time, a service capacity, and the like when a subscriber connected to the carrier ethernet backbone network 2 via the access network 3 requests setting/canceling of services, and provides basic data about a subscriber centralized service fee calculation based on information such as service use time and service capacity in which subscribers actually use corresponding services through network service providers in accordance with service use information of the subscribers.

Meanwhile, a VPN setting method and a VPN management method have a variety of embodiments, and the methods are not limited to individual functions thereof. However, in a variety of embodiments, it is prerequisite that a VPN linking the carrier ethernet backbone network 2 and the access network 3 has to be set, and the set VPN has to be centrally managed.

The resource management unit 102 requests resource information from each of the edge devices of the carrier ethernet backbone network 2 and the access network 3 to thereby receive information indicating whether the VPN setting is possible. In this instance, the VPN setting and management unit 104 sets the VPN connecting the carrier ethernet backbone network 3 and the access network 2 based on the service profile defined by the profile definition unit 100 when receiving a VPN setting enabled response signal in response to a request for the resource information from the resource management unit 102.

FIG. 3 is a detailed configuration diagram illustrating a profile definition unit according to an embodiment of the present invention.

Referring to FIGS. 1 and 3, the profile definition unit 100 includes a connection information query unit 1000, a service selection unit 1002, and a service level agreement (SLA) selection unit 1004.

The connection information query unit 1000 selects a subscriber to be provided with the VPN services and queries about connection information between the edge devices of the carrier ethernet backbone network 2 and the access network 3 to provide the VPN services to the selected subscriber. According to an embodiment, the connection information query unit 1000 queries about an IP address and interface information of the edge device 20 of the carrier ethernet backbone network 2 and terminal information of an optical line terminal (OLT) of the access network 3.

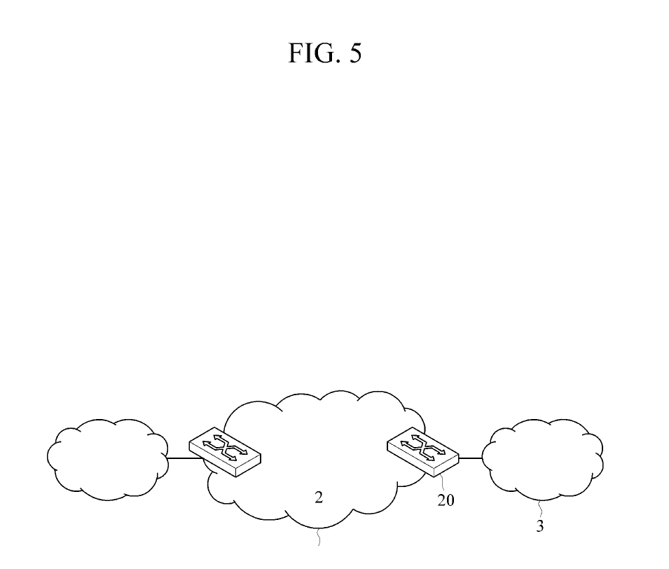

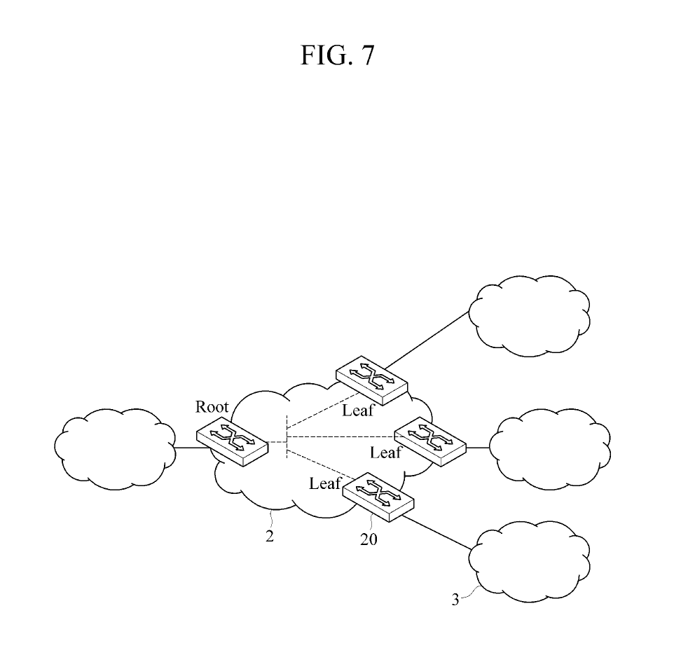

The service selection unit 1002 selects a service type to be used in the carrier ethernet backbone network 2 to provide the VPN services. According to an embodiment, the service selection unit 1002 selects one of E-line, E-LAN, and E-tree services. A service type selection example of the service selection unit 1002 will be described below with reference to FIGS. 5 and 7.

The SLA selection unit 1004 selects quality information of the VPN services. The quality information of the service includes parameters such as QoS, bandwidth, delay, jitter, and the like.

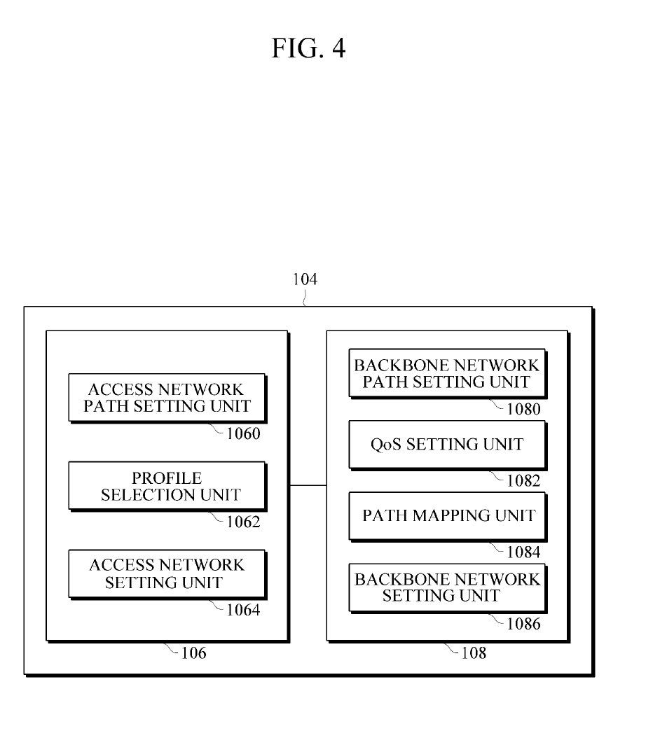

FIG. 4 is a detailed configuration diagram illustrating the VPN setting and management unit 104 according to an embodiment of the present invention.

Referring to FIG. 4, the VPN setting and management unit 104 includes a first VPN setting unit 106 and a second VPN setting unit 108.

The first VPN setting unit 106 sets an access network transmission path and performs provisioning in accordance with the set access network transmission path. For this, the first VPN setting unit 106 includes an access network path setting unit 1060, a profile selection unit 1062, and an access network setting unit 1064.

The access network path setting unit 1060 sets the access network transmission path including an ONU and an OLT.

The profile selection unit 1062 selects an S-VLAN ID and service profile of the access network transmission path.

The access network setting unit 1064 performs provisioning in accordance with the access network transmission path based on the S-VLAN ID and service profile selected by the profile selection unit 1062.

The second VPN setting unit 108 sets a carrier ethernet backbone network transmission path, maps the set carrier ethernet backbone network transmission path in the access network transmission path, and performs provisioning in accordance with the carrier ethernet backbone network transmission path. For this, the second VPN setting unit 108 includes a backbone network path setting unit 1080, a QoS setting unit 1082, a path mapping unit 1084, and a backbone network setting unit 1086.

The backbone network path setting unit 1080 sets the carrier ethernet backbone network transmission path.

The QoS setting unit 1082 sets a QoS of the carrier ethernet backbone network transmission path.

The path mapping unit 1084 maps the carrier ethernet backbone network transmission path in the access network transmission path. For this, the S-VLAN ID is mapped in a corresponding port of an edge device of the backbone network.

The backbone network setting unit 1086 performs provisioning in accordance with the carrier ethernet backbone network transmission path based on the mapping result of the path mapping unit 1084.

FIG. 5 is an example diagram illustrating a selection example of a service type to be used in a carrier ethernet backbone network for providing VPN services according to an embodiment of the present invention.

Referring to FIGS. 1 and 5, the apparatus 1 for providing the VPN services sets point-to-point EVC between edge devices positioned at network entry points among the edge devices constituting the carrier ethernet backbone network 2 to thereby provide E-line services.

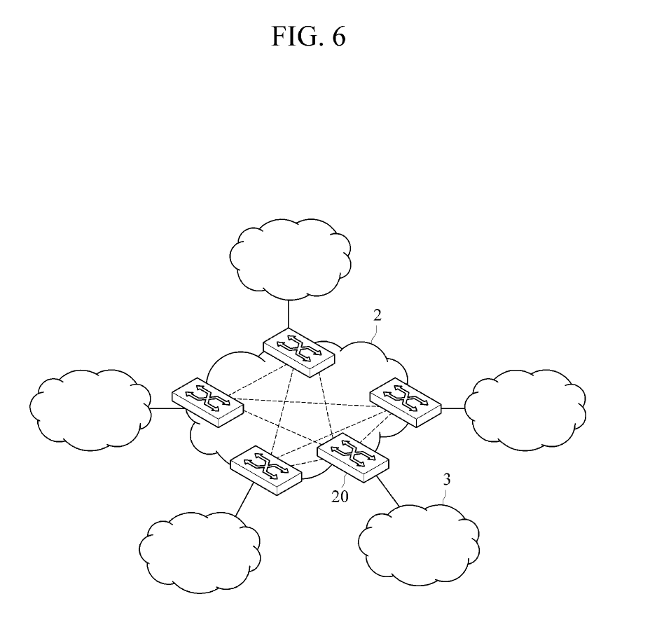

FIG. 6 is an example diagram illustrating a selection example of a service type to be used in a carrier ethernet backbone network for providing VPN services according to another embodiment of the present invention.

Referring to FIGS. 1 and 6, the apparatus 1 sets a full messy type, that is, multipoint-to-multipoint EVC between all edge devices positioned at entry points of the carrier ethernet backbone network 2 to thereby providing E-LAN services.

The E-LAN services may be used as a method of providing IPTV services or multicast services.

FIG. 7 is example diagram illustrating a selection example of a service type to be used in a carrier ethernet backbone network for providing VPN services according to still another embodiment of the present invention.

Referring to FIGS. 1 and 7, the apparatus 1 sets rooted-multipoint EVC to thereby provide E-tree services. The E-tree services have characteristics such that traffic entering an edge device set as a root is transmitted to all edge devices set as a leaf, but the traffic entering the edge set as the leaf is not transmitted to edge devices set as another leaf and transmitted only to the edge devices set as the root.

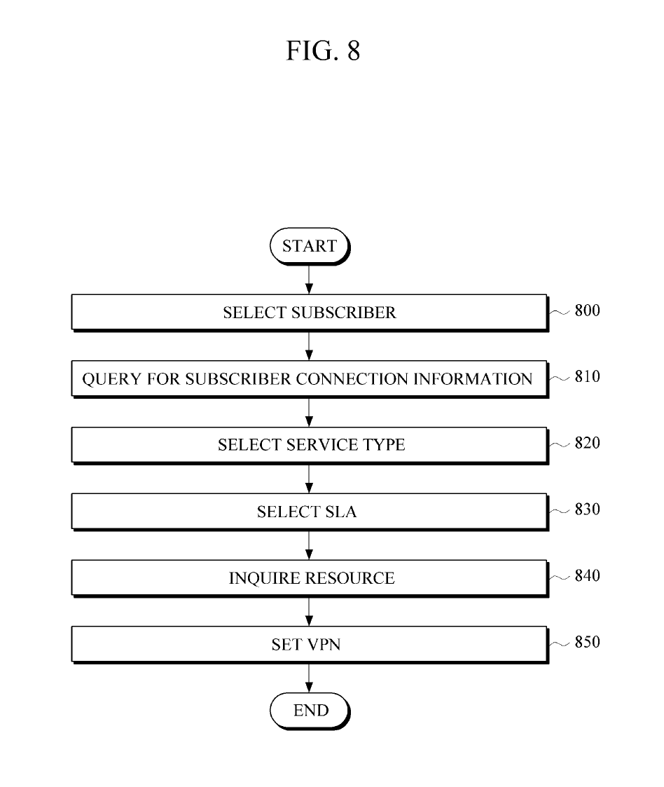

FIG. 8 is a flowchart illustrating a method of providing VPN services between edge devices of an apparatus 1 for controlling the VPN services in an integrated network environment including a carrier ethernet backbone network and an access network according to an embodiment of the present invention.

Referring to FIGS. 1 and 8, processes 800 to 830 from selecting a subscriber of the apparatus 1 to selecting an SLA are all operations of defining a profile required for VPN setting.

In other words, in operation 800, the apparatus 1 selects subscribers to be provided with the VPN services.

In operation 810, the apparatus queries about connection information required for providing the VPN services to the selected subscriber. For example, the apparatus 1 queries about an IP address and interface information of the edge device 20 of the carrier ethernet backbone network 2 and terminal information of an OLT 30 of the access network 3.

Next, in operation 820, the apparatus 1 selects a service type to be used in the carrier ethernet backbone network 2 to provide the VPN services, that is, selects one of E-line, E-LAN, and E-tree services.

In operation 830, the apparatus 1 selects quality information of the VPN services, for example, parameters such as QoS, bandwidth, delay, jitter, and the like, and adds the selected quality information in the profile.

In operation 840, the apparatus 1 requests resource information from the OLT 30 of the access network 3 and the edge device 20 of the carrier ethernet backbone network 2 to set VPN satisfying a value defined in the profile.

In operation 850, the apparatus 1 performs a corresponding VPN setting process when receiving a VPN setting enabled response signal in response to a request for the resource information.

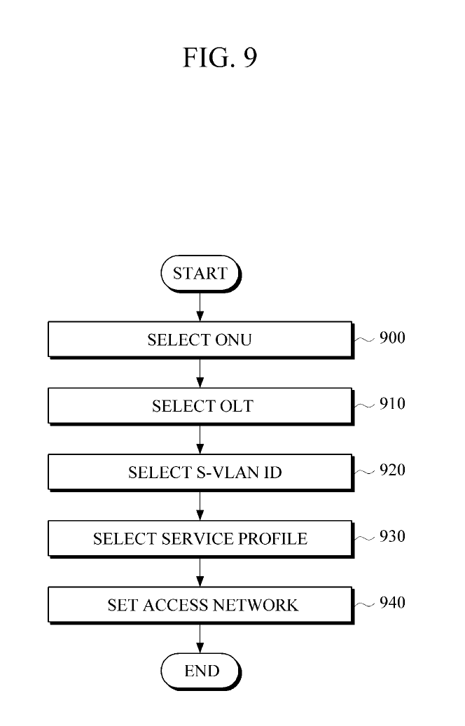

FIG. 9 is a flowchart illustrating in detail a VPN setting process of an access network in the VPN setting process 850 of FIG. 8.

Referring to FIGS. 1 and 9, in operations 900 and 910, the apparatus 1 selects an ONU 32 and an OLT 30 of the access network 3 to be provided with VPN services.

In operations 920 and 930, the apparatus 1 selects an S-VLAND ID and a service profile to be applied to a transmission path including the selected ONU 32 and OLT 30.

In operation 940, the apparatus 1 performs provisioning.

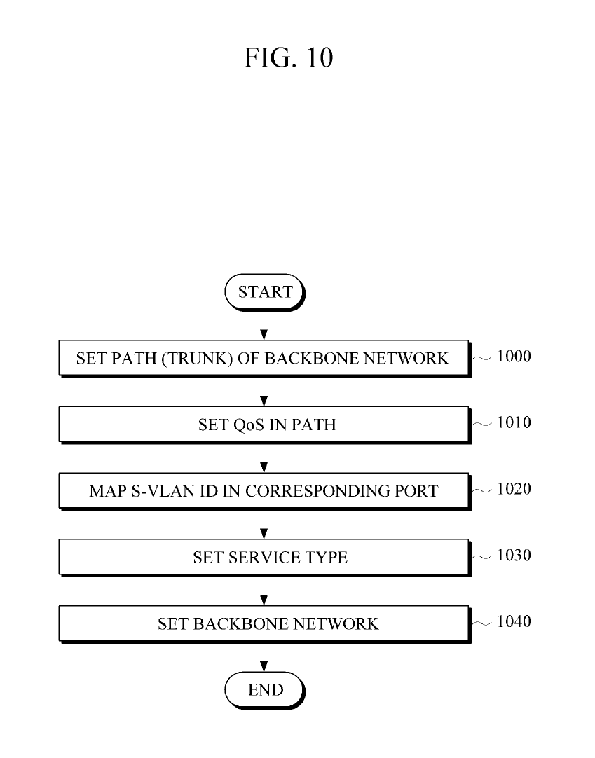

FIG. 10 is a flowchart illustrating in detail a VPN setting process of a carrier ethernet backbone network the VPN setting process 850 of FIG. 8.

Referring to FIGS. 1 and 10, in operation 1000, the apparatus 1 sets a transmission path to be used for providing VPN services in the carrier ethernet backbone network 2.

In operation 1010, the apparatus 1 applies a corresponding QoS to the transmission path.

In operation 1020, the apparatus 1 maps a corresponding S-VLAN ID so that a transmission path of the carrier ethernet backbone network 2 is mapped in a transmission path which is set in the ONU 32 and the OLT 30 of the access network 3.

In operation 1030, the apparatus 1 selects one of carrier ethernet service types to be applied.

In operation 1040, the apparatus 1 performs provisioning on the transmission path.

As described above, according to an embodiment, in an integrated network including an MPLS-TP or PBB-TE-based carrier ethernet backbone network and a plurality of FTTH-based access networks, high quality QoS may be ensured by setting VPN connecting the carrier ethernet backbone network and the access network.

In addition, by centrally managing the carrier ethernet backbone network and the access network to provide VPN services, a network operator may significantly reduce the quantity of setting the backbone network and the access network to provide the VPN services.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling virtual private network (hereinafter, referred to as “VPN”) services between edge devices in an integrated network environment including a carrier ethernet backbone network and an access network, the apparatus comprising:
a profile definition unit that defines a service profile required for VPN setting between the edge devices connected to the carrier ethernet backbone network via the access network; and
a VPN setting and management unit that sets a VPN connecting the carrier ethernet backbone network and the access network based on the service profile defined by the profile definition unit, and centrally manages the carrier ethernet backbone network and the access network to provide the VPN services.

2. The apparatus according to claim 1, further comprising:
a resource management unit that requests resource information from each of edge devices of the carrier ethernet backbone network and the access network to thereby receive information indicating whether the VPN setting is possible,
wherein the VPN setting and management unit sets the VPN connecting the carrier ethernet backbone network and the access network based on the service profile defined by the profile definition unit when receiving a VPN setting enabled response signal in response to a request for the resource information from the resource management unit.

3. The apparatus according to claim 1, wherein the profile definition unit comprises:
a connection information query unit that selects a subscriber to be provided with the VPN services and queries about connection information between edge devices of the carrier ethernet backbone network and the access network to provide the VPN services to the selected subscriber;
a service selection unit that selects a service type to be used in the carrier ethernet backbone network to provide the VPN services; and
a service level agreement (SLA) selection unit that selects quality information of the VPN services.

4. The apparatus according to claim 3, wherein the connection information query unit queries about an IP address and interface information of the edge device of the carrier ethernet backbone network and terminal information of an optical line terminal (OLT) of the access network.

5. The apparatus according to claim 3, wherein the service selection unit selects one of E-line, E-LAN, and E-tree services.

6. The apparatus according to claim 1, wherein the VPN setting and management unit comprises:
a first VPN setting unit that sets an access network transmission path and performs provisioning in accordance with the set access network transmission path; and
a second VPN setting unit that sets a carrier ethernet backbone network transmission path, maps the set carrier ethernet backbone network transmission path in the access network transmission path, and performs provisioning in accordance with the carrier ethernet backbone network transmission path.

7. The apparatus according to claim 6, wherein the first VPN setting unit comprises:
an access network path setting unit that sets the access network transmission path including an optical network unit (ONU) and an OLT;
a profile selection unit that selects an S-VLAN ID and service profile of the access network transmission path; and
an access network setting unit that performs provisioning in accordance with the access network transmission path based on the selected S-VLAN ID and service profile.

8. The apparatus according to claim 6, wherein the second VPN setting unit comprises:
a backbone network path setting unit that sets the carrier ethernet backbone network transmission path;
a quality of service (QoS) setting unit that sets a QoS of the carrier ethernet backbone network transmission path;
a path mapping unit that maps the carrier ethernet backbone network transmission path in the access network transmission path; and
a backbone network setting unit that performs provisioning in accordance with the carrier ethernet backbone network transmission path based on the mapping result of the path mapping unit.

9. A method of controlling VPN services by an apparatus for controlling the VPN services in an integrated network environment including a carrier ethernet backbone network and an access network, the method comprising:
defining a service profile required for VPN setting between edge devices connected to the carrier ethernet backbone network via the access network; and
setting a VPN connecting the carrier ethernet backbone network and the access network based on the defined service profile;
centrally managing the carrier ethernet backbone network and the access network to provide the VPN services.

10. The method according to claim 9, further comprising:
requesting resource information from each of edge devices of the carrier ethernet backbone network and the access network to thereby receive information indicating whether the VPN setting is possible, wherein the setting the VPN sets the VPN connecting the carrier ethernet backbone network and the access network based on the defined service profile when receiving a VPN setting enabled response signal in response to a request for the resource information.

11. The method according to claim 9, wherein the defining the service profile comprises:
selecting a subscriber to be provided with the VPN services and querying about connection information between edge devices of the carrier ethernet backbone network and the access network to provide the VPN services to the selected subscriber;
selecting a service type to be used in the carrier ethernet backbone network to provide the VPN services; and
selecting quality information of the VPN services.

12. The method according to claim 9, wherein the setting the VPN comprises:
setting an access network transmission path and performing provisioning in accordance with the set access network transmission path; and
setting a carrier ethernet backbone network transmission path, mapping the set carrier ethernet backbone network transmission path on the access network transmission path, and performing provisioning in accordance with the carrier ethernet backbone network transmission path.

13. The method according to claim 12, wherein the setting the access network transmission path comprises:
setting the access network transmission path including an ONU and an OLT;
selecting an S-VLAN ID and service profile of the access network transmission path; and
performing provisioning in accordance with the access network transmission path based on the selected S-VLAN ID and service profile.

14. The method according to claim 12, wherein the setting the backbone network transmission path comprises:
setting the carrier ethernet backbone network transmission path;
setting a QoS of the carrier ethernet backbone network transmission path;
mapping the carrier ethernet backbone network transmission path on the access network transmission path; and
performing provisioning in accordance with the carrier ethernet backbone network transmission path based on the mapping result.
